(19) United States
(12) Patent Application Publication
(10) Pub. No.: US 2013/0208218 A1
(43) Pub. Date: Aug. 15, 2013

(54) COLOR FILTER AND DISPLAY DEVICE

(71) Applicants: Yasuhiro Kohara, Osaka-shi (JP); Akira Nakagawa, Osaka-shi (JP); Hidekazu Ohshima, Osaka-shi (JP); Tohru Sakata, Osaka-shi (JP)

(72) Inventors: Yasuhiro Kohara, Osaka-shi (JP); Akira Nakagawa, Osaka-shi (JP); Hidekazu Ohshima, Osaka-shi (JP); Tohru Sakata, Osaka-shi (JP)

(73) Assignee: SHARP KABUSHIKI KAISHA, Osaka (JP)

(21) Appl. No.: 13/641,948

(22) PCT Filed: Feb. 10, 2011
(86) PCT No.: PCT/JP2011/052832

§ 371 Date: Oct. 18, 2012

(30) Foreign Application Priority Data
Apr. 22, 2010 (JP) 2010-098950

(51) Int. Cl. G02F 1/1335; G02B 5/20

(52) U.S. Cl. CPC G02F 1/133514; G02B 5/20
USPC 349/106; 359/891

(57) ABSTRACT

On a color filter substrate (color filter) that displays a plurality of colors that are different from each other, a base material, first and second color filter layers that are formed on the base material and respectively colored yellow and magenta, a first overcoat layer that functions as a color filter layer colored red, and a second overcoat layer that is provided so as to cover the first and second color filter layers and colored cyan are provided.

### TECHNICAL FIELD

The present invention relates to a color filter used in color display or the like, and a display device using the color filter.

### BACKGROUND ART

In recent years, liquid crystal display devices, for example, have been used widely as flat panel displays in liquid crystal televisions, monitors, mobile phones, and the like, that have features such as being thinner, lighter, etc. than conventional cathode-ray tubes. Such liquid crystal display devices contain a lighting device (backlight device) that emits light and a liquid crystal panel that displays desired images by acting as a shutter for light from a light source provided in the lighting device.

Further, the liquid crystal panel as described above includes a liquid crystal layer containing liquid crystal molecules and a pair of substrates that sandwich the liquid crystal layer. Additionally, in the liquid crystal panel, multiple pixels are provided in an effective display area. These multiple pixels are generally designed to display, by a color filter layer of the colors red (R), green (G), and blue (B), which is formed on a color filter substrate serving as one substrate in the pair of substrates, the corresponding color.

In other words, in a conventional liquid crystal display device, color display has been performed by providing the color filter substrate configured by a conventional color filter.

Further, in the conventional color filter, as described in the Patent document 1 below, for example, a light-shielding pattern and a color pattern composed of a red pattern, a green pattern, and a blue pattern are formed on a light-transmissive substrate such as a glass substrate or the like. Additionally, in this conventional color filter, it has been proposed to provide a transparent planarization layer so as to cover the light-shielding pattern and the color pattern, and to sequentially provide, on the planarization layer, at least one light-transmissive inorganic films, selected from the group consisting of an inorganic oxide film, an inorganic nitride film, an inorganic oxynitride film, and an inorganic carbide film, and a transparent electrode (common electrode). In addition, with this conventional color filter, even if post-baking is performed on the planarization layer, film shrinkage of the planarization layer caused by the light-transmissive inorganic film at the time of post-baking can be suppressed and it was considered possible to prevent the formation of level differences on the surface of the planarization layer. Moreover, with the conventional color filter, it has been assumed that poor attachment of the transparent electrode to the film caused by level differences on the planarization layer and a drop in display quality caused by disturbance of the liquid crystal orientation in the liquid crystal display device can be prevented.

### CITATION LIST

### Patent Document

Patent Document 1: JP 2009-98567A

### DISCLOSURE OF INVENTION

### Problem to be Solved by the Invention

However, with the conventional color filter as described above, since displaying RGB colors is performed by forming color patterns (color filter layers) of red (R), green (G), and blue (B) on the light-transmissive substrate (base) individually, the degree of freedom of color displayed with the color filter cannot be improved easily, and thus a problem occurs in which it is difficult to expand the color reproduction range.

Further, with the conventional color filter, since the planarization layer (overcoat layer) is provided so as to cover the above-mentioned color patterns, light is absorbed by the planarization layer, and thus a problem occurs in which the light use efficiency drops.

In view of the above-mentioned problems, it is an object of the present invention to provide a color filter with the excellent light use efficiency, that enables the color reproduction range to be expanded by allowing the degree of freedom of displayed color to be improved, and a display device using the color filter.

### Means for Solving Problem

In order to achieve the above-described object, a color filter according to the present invention is a color filter that displays a plurality of colors that are different from each other, and includes a base material, a color filter layer that is formed on the base material and colored with a predetermined color, and an overcoat layer that is provided on the base material so as to cover the color filter layer and colored with a color different from the predetermined color of the color filter layer.

With the color filter that is configured as described above, a color filter layer colored with a predetermined color is provided on a base material. Also, on the base material, an overcoat layer that is provided on the base material so as to cover the color filter layer and be colored with a color different from the color of the color filter layer is provided. Accordingly, the overcoat layer is caused to function as the color filter layer. Therefore, different from the above-described conventional example, it is possible to configure a color filter with the excellent light use efficiency, that enables the color reproduction range to be expanded by allowing the degree of freedom of displayed color to be easily improved.

Also, with the above-described color filter, it is preferable that a plurality of color filter layers colored with colors that are different from each other are used as the color filter layer, and a plurality of overcoat layers colored with colors that are different from each other are used as the overcoat layer.

In this case, it is possible to easily configure a color filter that can prevent a drop in the light use efficiency and perform color display of three or more colors.

Also, with the above-described color filter, it is preferable that a first overcoat layer colored with any of the colors red (R), green (G), and blue (B), and a second overcoat layer colored with a color, among cyan (C), magenta (M), and yellow (Y), that is in a complementary color relation with the color of the first overcoat layer are used as the plurality of overcoat layers, and a first color filter layer and a second color filter layer that are provided so as to be covered by the second overcoat layer and are respectively colored with one and the other color of two colors, among cyan (C), magenta (M), and yellow (Y), that are different from the color of the second overcoat layer are used as the plurality of color filter layers.

In this case, it is possible to easily configure a color filter that can prevent a drop in the light use efficiency and perform color display of three or more colors including the colors red (R), green (G), and blue (B).

Also, in a display device of the present invention, the color filter of any of the above-described color filters is used.

With the display device that is configured as described above, since the color filter with excellent light use efficiency, that enables the color reproduction range to be expanded by allowing the degree of freedom of displayed color to be improved is used, it is possible to easily configure a liquid crystal display device with high-brightness, excellent display quality, and high performance.

Also, the above-described display device may include a display unit that displays information, and a liquid crystal panel may be used for the display unit.

In this case, it is possible to easily configure a liquid crystal device with high-brightness, excellent display quality, and high performance.

Also, with the above-described display device, it is preferable that the color filter is used as one substrate of a pair of substrates that sandwich a liquid crystal layer of the liquid crystal panel, and the overcoat layer constitutes a planarization layer that is provided on the liquid crystal layer side.

In this case, even if the color filter is provided so as to sandwich the liquid crystal layer, it is possible to prevent occurrence of disturbance of the liquid crystal orientation in the liquid crystal layer and easily configure the liquid crystal display device with excellent display quality.

### Effects of the Invention

According to the present invention, it is possible to provide a color filter with excellent light use efficiency, that enables the color reproduction range to be expanded by allowing the degree of freedom of displayed color to be improved, and a display device using the color filter.

### BRIEF DESCRIPTION OF DRAWINGS

FIG. 1 is a diagram illustrating a liquid crystal display device according to a first embodiment of the present invention.

FIG. 2 is a diagram illustrating a configuration of a liquid crystal panel shown in FIG. 1.

FIG. 3 is a diagram illustrating a configuration of a main portion of a color filter substrate shown in FIG. 1.

FIG. 4 is a diagram illustrating a configuration of a main portion of a color filter substrate in a liquid crystal display device according to a second embodiment of the present invention.

FIG. 5 is a diagram illustrating a configuration of a main portion of a color filter substrate in a liquid crystal display device according to a third embodiment of the present invention.

FIG. 6 is a diagram illustrating a configuration of a main portion of a color filter substrate in a liquid crystal display device according to a fourth embodiment of the present invention.

### DESCRIPTION OF EMBODIMENTS

Hereinafter, preferred embodiments of a color filter and a display device of the present invention will be described with reference to the drawings. Note that in the description below, the invention is discussed using examples in which the present invention is applied to a transmissive-type liquid crystal display device. Also, the dimensions of constituent elements in the drawings are not precise representations of the actual dimensions or dimensional ratios thereof.

### First Embodiment

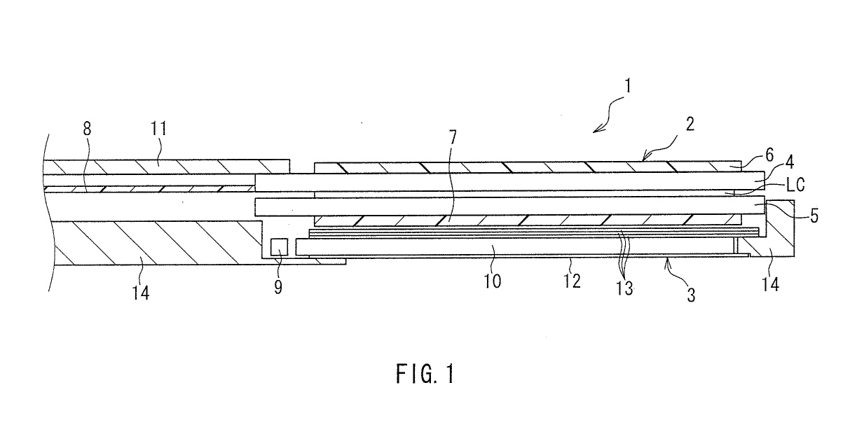

FIG. 1 is a diagram illustrating a liquid crystal display device according to a first embodiment of the present invention. In FIG. 1, a liquid crystal display device 1 of the present embodiment is provided with a liquid crystal panel 2 that is installed with an upper side in FIG. 1 being a viewing side (display surface side), and a backlight device 3 that is disposed on a non-display surface side (lower side in FIG. 1) of the liquid crystal panel 2 and emits illumination light for illuminating the liquid crystal panel 2.

The liquid crystal panel 2 includes a color filter substrate 4 and an active matrix substrate 5, which respectively constitute one substrate and the other substrate of a pair of substrates, and polarizing plates 6 and 7, which are provided on the respective exterior surfaces of the color filter substrate 4 and the active matrix substrate 5. A liquid crystal layer LC is sandwiched between the color filter substrate 4 and the active matrix substrate 5. Also, plate-shaped transparent glass materials or transparent synthetic resins, such as an acrylic resin or the like, are used as the color filter substrate 4 and the active matrix substrate 5. Resin films made of TAC (triacetyl cellulose), PVA (polyvinyl alcohol), or the like, are used as the polarizing plates 6 and 7, and are adhered to the corresponding color filter substrate 4 or active matrix substrate 5 so as to cover at least an effective display area of the display surface provided on the liquid crystal panel 2.

Also, pixel electrodes, thin film transistors (TFT) and the like are formed on the active matrix substrate 5 between the substrate thereof and the above-described liquid crystal layer LC in correspondence with multiple pixels present on the display surface of the liquid crystal panel 2 (details are described later). On the other hand, the color filter substrate 4 is configured by a color filter of the present invention, and a color filter layer, an overcoat layer, a common electrode, and the like, which are described later, are formed on the color filter substrate 4 between the substrate thereof and the above-described liquid crystal layer LC.

Also, an FPC (flexible printed circuit) 8 that is connected to a control device (not shown) for controlling the actuation of the liquid crystal panel 2 is provided in the liquid crystal panel 2, and by operating the above-described liquid crystal layer LC on a pixel-by-pixel basis, the display surface is driven on a pixel-by-pixel basis to display desired images on the display surface.

Note that a liquid crystal mode and pixel structure of the liquid crystal panel 2 are arbitrary. Also, a driving mode of the liquid crystal panel 2 is arbitrary. That is, an arbitrary liquid crystal panel that is capable of displaying information can be used as the liquid crystal panel 2. Therefore, in FIG. 1, the detailed structure of the liquid crystal panel 2 is not shown and description thereof is also omitted.

The backlight device 3 includes a light-emitting diode 9 serving as a light source, and a light guiding plate 10 disposed so as to face the light-emitting diode 9. Also, in the backlight device 3, the light-emitting diode 9 and the light guide panel 10 are held by a bezel 14 that has an L-shaped cross-section, in a state in which the liquid crystal panel 2 is installed above the light guiding plate 10. Also, a case 11 is placed on the color filter substrate 4. Accordingly, the backlight device 3 is assembled to the liquid crystal panel 2, and integrated to form the transmissive-type liquid crystal display device 1, in which illumination light from the backlight device 3 is incident on the liquid crystal panel 2.

A synthetic resin such as a transparent acrylic resin, for example, is used for the light guiding plate 10, with light from the light-emitting diode 9 being directed into the light guiding plate 10. A reflective sheet 12 is disposed on the surface of the light guiding plate 10 that faces away (surface that faces outwardly) from the liquid crystal panel 2. Also, optical sheets 13 such as lens sheets, diffuser sheets, or the like are provided on the liquid crystal panel 2 side of the light guiding plate 10 (light-emitting surface side), and light from the light-emitting diode 9 that is guided in a predetermined light-guiding direction (from left to right in FIG. 1) into the light guiding plate 10 is transformed into the above-mentioned planar illumination light with uniform brightness and supplied to the liquid crystal panel 2.

Note that although a configuration using the edge-light backlight device 3 equipped with the light guiding plate 10 is described in the above description, the present embodiment is not limited thereto, and a direct-light backlight device 3 may also be used. Also, a backlight device equipped with another light source, other than a light-emitting diode, such as a cold cathode fluorescent lamp or a hot cathode fluorescent lamp may also be used.

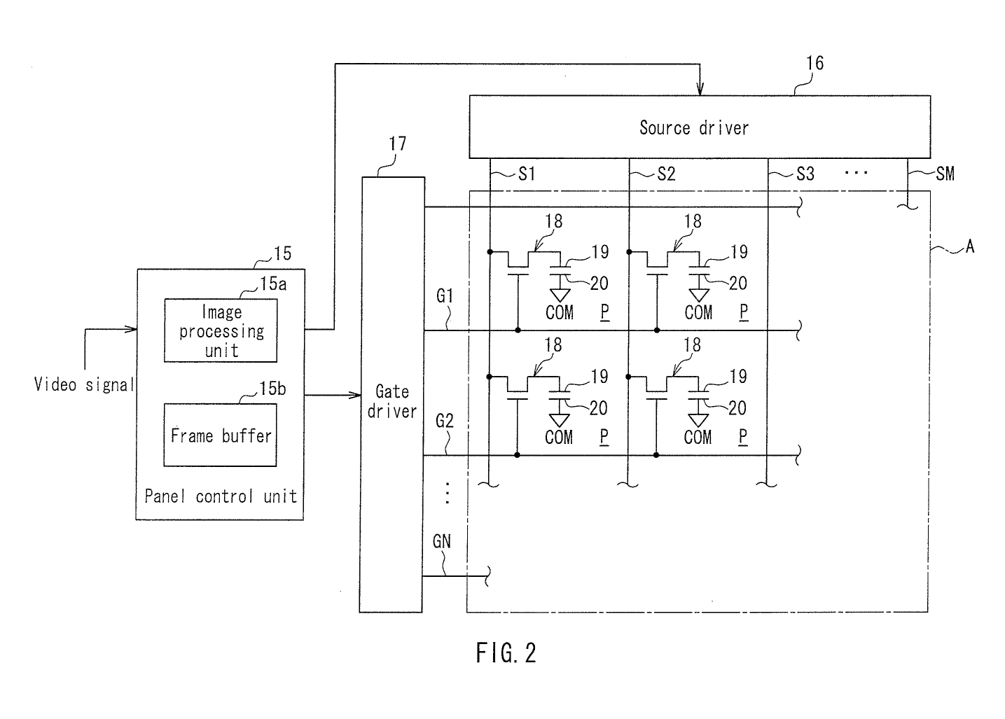

Next, the liquid crystal panel 2 of the present embodiment will be specifically described with reference to FIG. 2.

FIG. 2 is a diagram illustrating a configuration of the liquid crystal panel shown in FIG. 1.

In FIG. 2, a panel control unit 15, which controls the actuation of the liquid crystal panel 2 (FIG. 1) serving as the above-described display unit used for displaying information such as text, images, and the like, a source driver 16 and a gate driver 17, which operate based on instruction signals received from the panel control unit 15, are provided in the liquid crystal display device 1 (FIG. 1).

The panel control unit 15 is provided in the above-described control device, and receives a video signal from outside of the liquid crystal display device 1. Also, the panel control unit 15 includes an image processing unit 15a, which generates instruction signals for the source driver 16 and the gate driver 17 by performing predetermined image processing on the received video signal, and a frame buffer 15b, which is capable of storing display data for a single frame contained in the received video signal. In addition, the panel control unit 15 controls the actuation of the source driver 16 and the gate driver 17 according to the received video signal, as a result of which information corresponding to the video signal is displayed on the liquid crystal panel 2.

The source driver 16 and the gate driver 17 are installed on the active matrix substrate 5. Specifically, the source driver 16 is installed on the surface of the active matrix substrate 5 along the horizontal direction of the liquid crystal panel 2 in a region located outside of the effective display area A of the liquid crystal panel 2 serving as a display panel. Also, the gate driver 17 is disposed on the surface of the active matrix substrate 5 along the vertical direction of the liquid crystal panel 2 in a region located outside of the above-described effective display area A.

Additionally, the source driver 16 and the gate driver 17 are drive circuits for driving multiple pixels P provided on the liquid crystal panel 2 on a pixel-by-pixel basis, and multiple source lines S1-SM (where M is an integer of 2 or more, hereinafter collectively referred to as “S”) and multiple gate lines G1-GN (where N is an integer of 2 or more, hereinafter collectively referred to as “G”) are respectively connected to the source driver 16 and the gate driver 17. These source lines S and gate lines G respectively constitute data lines and scanning lines, and are arranged in a matrix such that they cross each other on a base material (not shown) made of a transparent glass material or a transparent synthetic resin contained in the active matrix substrate 5. Specifically, the source lines S are provided on the base material such that they are parallel to the column direction of the matrix (vertical direction of liquid crystal panel 2), and the gate lines G are provided on the base material such that they are parallel to the row direction of the matrix (horizontal direction of liquid crystal panel 2).

Also, thin film transistors 18 serving as a switching element, and the above-described pixels P having a pixel electrode 19 connected to the thin film transistor 18 are provided in the vicinity of intersections between these source lines S and gate lines G. Further, in each pixel P, a common electrode 20 is formed facing the pixel electrode 19, such that the above-described liquid crystal layer LC provided in the liquid crystal panel 2 is sandwiched therebetween. In other words, in the active matrix substrate 5, the thing film transistors 18, pixel electrodes 19, and the common electrodes 20 are provided on a pixel-by-pixel basis.

Also, regions for multiple pixels P are formed on the active matrix substrate 5 in regions that are partitioned by the source lines S and the gate lines G into a matrix. These multiple pixels P include red (R), green (G), and blue (B) pixels. Further, these RGB pixels are arranged sequentially, for example, in the above-mentioned order, in parallel to the gate lines G1-GN. Additionally, these RGB pixels are designed to be capable of displaying the corresponding colors by a color filter layer and an overcoat layer (not shown), which are described later, that are provided on the color filter substrate 4 side.

Also, the gate driver 17 on the active matrix substrate 5, based on instruction signals from the image processing unit 15a, sequentially outputs scanning signals (gate signals) that turn the gate electrodes of the corresponding thin film transistors 18 on for the gate lines G1-GN. Further, the source driver 16, based on instruction signals from the image processing unit 15a, outputs data signals (voltage signals (gradation voltage)) corresponding to the brightness (gradation) of the displayed images to the corresponding source lines S1-SM.

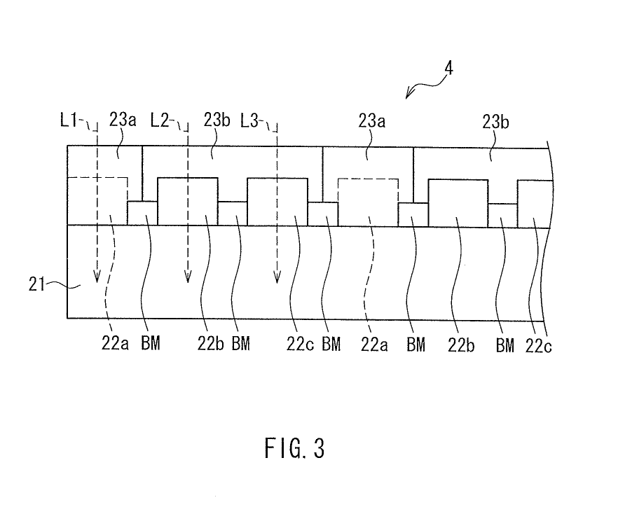

Next, a configuration of a main portion of the color filter substrate 4 of the present embodiment is specifically described with reference to FIG. 3.

FIG. 3 is a diagram illustrating a configuration of a main portion of the color filter substrate shown in FIG. 1.

As shown in FIG. 3, the color filter substrate 4 of the present embodiment includes a base material 21 made of a transparent glass material, a transparent synthetic resin material, or the like, a first overcoat layer 23a that functions as a color filter layer 22a formed on the base material 21, first and second color filter layers 22b and 22c formed on the base material 21, a second overcoat layer 23b provided on the base material 21 so as to cover the first and second color filter layers 22b and 22c. Additionally, on the color filter substrate 4, a black-matrix BM is provided in a gap between two color filter layers, which are adjacent each other on the base material 21, of the color filter layers 22a-22c, and is designed to partition pixels P of the above-described RGB pixels.

The first and second color filter layers 22b and 22c are respectively colored with predetermined colors such as yellow (Y) and magenta (M), for example. Also, the first overcoat layer 23a is colored red (R), for example, and is directly provided on the base material 21 so as to be partitioned by the black-matrix BM, and thereby functions as the color filter layer 22a colored red (R). Additionally, the second overcoat layer 23b is colored cyan (C), for example, which is in a complementary color relation with the color of the first overcoat layer 23a.

In addition, with the color filter substrate 4 of the present invention, displayed colors (transmissive colors) in the direction indicated by arrows L1, L2, and L3 in FIG. 3 are designed to be red (R), green (G), and blue (B). Specifically, red (R) is displayed in the direction indicated by the arrow L1 due to the color filter layer 22a (first overcoat layer 23a). Also, green (G) (=yellow (Y)+cyan (C)) is displayed in the direction indicated by the arrow L2 due to the mixed colors of the color filter layer 22b and the overcoat layer 23b, and blue (B) (=magenta (M)+cyan (C)) is displayed in the direction indicated by the arrow L3 due to the mixed colors of the color filter layer 22c and the second overcoat layer 23b.

Further, a planarization layer provided on the liquid crystal layer LC side is configured with the first and second overcoat layers 23a and 23b, and the surfaces of these first and second overcoat layers 23a and 23b are designed to be planarized surfaces. In addition, with the color filter substrate 4 of the present embodiment, the above-mentioned common electrodes 20 made of a transparent conductive film such as ITO are formed on the first and second overcoat layers 23a and 23b, so as to be in contact with the above-described liquid crystal layer LC.

With the color filter substrate (color filter) 4 of the present embodiment, which is configured as described above, the first overcoat layer 23a, which is colored red and functions as the color filter layer 22a, is formed on the base material 21. Also, the first and second color filter layers 22b and 22c, which are colored yellow and magenta respectively, and the second overcoat layer 23b, which are provided so as to cover these first and second color filter layers 22b and 22c and colored cyan, are formed on the base material 21. In this manner, with the color filter substrate 4 of the present embodiment, different from the above-described conventional example, since the overcoat layers are caused to function as color filter layers, it is possible to prevent a drop in the light use efficiency and perform RGB color display. Accordingly, in the present embodiment, different from the above-described conventional example, it is possible to configure the color filter substrate (color filter) 4 with the excellent light use efficiency, that enables the color reproduction range to be expanded by allowing the degree of freedom of displayed color to be improved.

Further, in the present embodiment, since the color filter substrate 4 with excellent light use efficiency, that enables the color reproduction range to be expanded by allowing the degree of freedom of displayed color to be improved is used, it is possible to easily configure the liquid crystal display device 1 with high-brightness, excellent display quality, and high performance.

Additionally, in the present embodiment, since a planarization layer provided on the liquid crystal layer LC side is configured with the first and second overcoat layers 23a and 23b, it is possible to prevent occurrence of disturbance of the liquid crystal orientation in the liquid crystal layer LC and easily configure the liquid crystal display device 1 with excellent display quality.

Also, other than the description of the above embodiment, the first overcoat layer 23a is colored with any of the colors red (R), green (G), and blue (B), and the second overcoat layer 23b is colored with colors that are in a complementary color relation with the color of the first overcoat layer 23a. Additionally, the first and second color filter layers 22b and 22c covered by the second overcoat layer 23b are respectively colored with one and the other color of two colors, among cyan (C), magenta (M), and yellow (Y), which are different from the color of the second overcoat layer 23b, and thereby it is possible to configure the color filter substrate 4 that can perform RGB color display. In other words, it is possible to perform RGB color display by selecting a No. 2 or No. 3 combination in TABLE 1 below other than a No. 1 combination in TABLE 1 described in the above embodiment.

TABLE 1

| | Displayed | Displayed | Displayed |
|---|---|---|---|
| | color in | color in | color in |
| Combination | arrow 1 | arrow 2 | arrow 3 |
| No. | direction | direction | direction |
| 1 | Red (R): | Green (G): | Blue (B): |
| | first | first color | second color |
| | overcoat | filter layer | filter layer |
| | layer 23a | | 22c |

### Second Embodiment

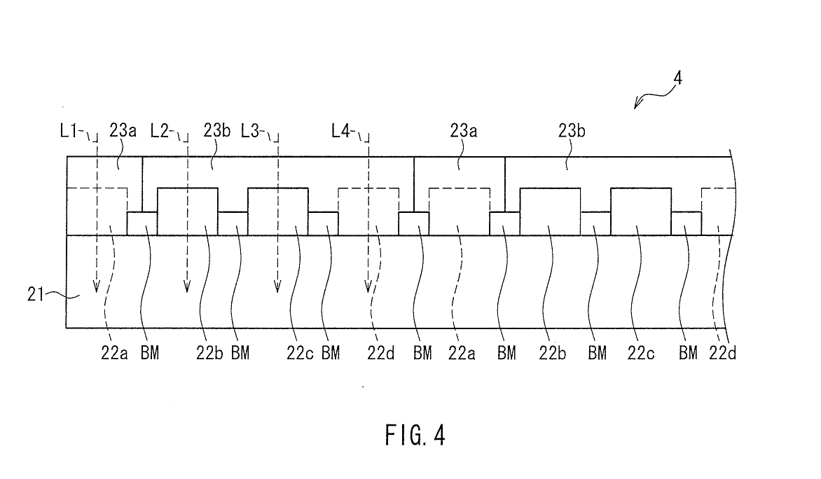

FIG. 4 is a diagram illustrating a configuration of a main portion of a color filter substrate in a liquid crystal display device according to a second embodiment of the present invention. In FIG. 4, the present embodiment is different from the above-described first embodiment 1 in that the second overcoat layer is caused to function as a color filter layer. Note that elements that are common with the above-described first embodiment are given the same reference numerals, and the redundant description thereof will be omitted.

Namely, as shown in FIG. 4, with the color filter substrate 4 of the present embodiment, the second overcoat layer 23b is directly provided on the base material 21 so as to be partitioned by the black-matrix BM. Accordingly, with the color filter substrate 4 of the present embodiment, the second overcoat layer 23b functions as a color filter layer 22d colored cyan (C). As a result, with the color filter substrate 4 of the present embodiment, displayed color (transmissive color) in the direction indicated by an arrow L4 in FIG. 4 is cyan (C).

With the configuration above, in the present embodiment, it is possible to achieve functions/effects similar to the above-described first embodiment. Also, in the present embodiment, since the second overcoat layer 23b is caused to function as a color filter layer 22d, it is possible to easily configure the color filter substrate 4 that can prevent a drop in the light use efficiency and perform color display of four colors RGBC.

Note that other than this description, it is possible to easily configure the color filter substrate 4 that can perform color display of four colors RGBM or RGBY if the combination No. 2 or No. 3 in TABLE 1 is selected.

### Third Embodiment

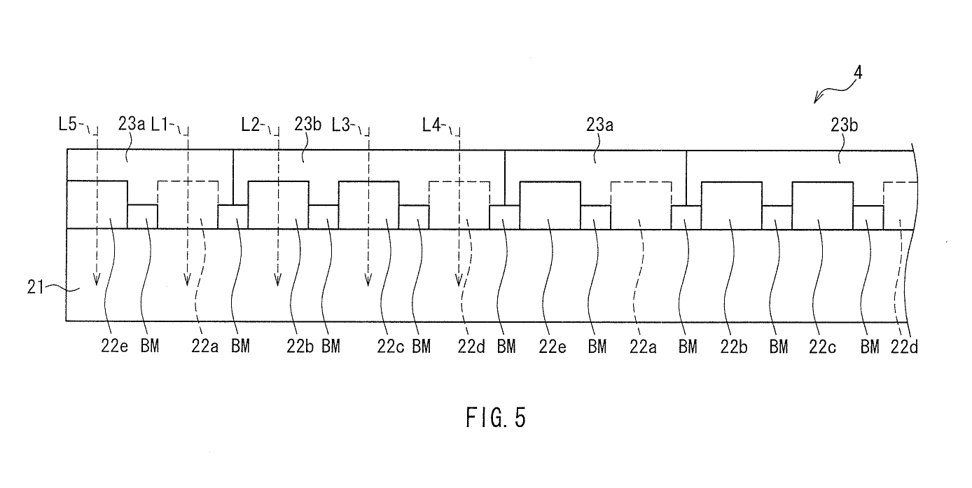

FIG. 5 is a diagram illustrating a configuration of a main portion of a color filter substrate in a liquid crystal display device according to a third embodiment of the present invention. In FIG. 5, the present embodiment is different from the above-described second embodiment in that a third color filter layer colored green is provided so as to be covered by the first overcoat layer. Note that elements that are common with the above-described second embodiment are given the same reference numerals, and the redundant description thereof will be omitted.

Namely, as shown in FIG. 5, with the color filter substrate 4 of the present embodiment, the third color filter layer 22e is provided on the base material 21 so as to be covered by the first overcoat layer 23a. The third color filter layer 22e is colored green (G), for example. Accordingly, with the color filter substrate 4 of the present embodiment, displayed color (transmissive color) in the direction indicated by an arrow L5 in FIG. 5 is yellow (Y) (=red (R)+green (G)) due to the mixed colors of the first overcoat layer 23a and the third color filter layer 22e.

With the configuration above, in the present embodiment, it is possible to achieve functions/effects similar to the above-described second embodiment. Also, in the present embodiment, since the third color filter layer 22e is provided on the base material 21 so as to be covered by the first overcoat layer 23a, it is possible to easily configure the color filter substrate 4 that can prevent a drop in the light use efficiency and perform color display of five colors RGBCY.

### Fourth Embodiment

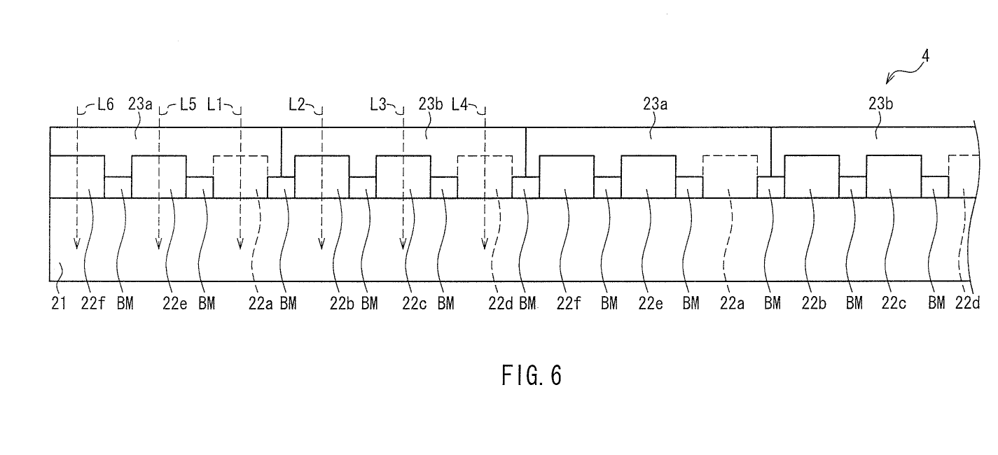

FIG. 6 is a diagram illustrating a configuration of a main portion of a color filter substrate in a liquid crystal display device according to a fourth embodiment of the present invention. In FIG. 6, the present embodiment is different from the above-described third embodiment in that a fourth color filter layer colored blue is provided so as to be covered by the first overcoat layer. Note that elements that are common with the above-described third embodiment are given the same reference numerals, and the redundant description thereof will be omitted.

Namely, as shown in FIG. 6, with the color filter substrate 4 of the present embodiment, the fourth color filter layer 22f is provided on the base material 21 so as to be covered by the first overcoat layer 23a. The fourth color filter layer 22f is colored magenta (M), among cyan (C), magenta (M), and yellow (Y), for example. Accordingly, with the color filter substrate 4 of the present embodiment, displayed color (transmissive color) in the direction indicated by an arrow L6 in FIG. 6 is reddish magenta (M) (=red (R)+magenta (M)) due to the mixed colors of the first overcoat layer 23a and the fourth color filter layer 22f.

With the configuration above, in the present embodiment, it is possible to achieve functions/effects similar to the above-described third embodiment. Also, in the present embodiment, since the fourth color filter layer 22f is provided on the base material 21 so as to be covered by the first overcoat layer 23a, it is possible to easily configure the color filter substrate 4 that can prevent a drop in the light use efficiency and perform color display of six colors RGBCYM (reddish M).

Note that all of the embodiments described above are merely illustrative, and not restrictive. The technical scope of the present invention is defined by the claims and all modifications that come within the range of equivalency of the configurations described herein are also included in the technical scope of the present invention.

For example, although in the description above the present invention was discussed using examples in which the present invention was applied to a transmissive-type liquid crystal display device, the color filters of the present invention are not limited thereto and can be suitably used for various types of display devices such as semi-transmissive-type liquid crystal display devices or projection-type display devices in which liquid crystal panels are used as light valves. Also, the color filter of the present invention can be applied to various types of electrical apparatuses such as mobile terminals and the like including mobile phones that perform color display.

Also, although in the description above the present invention was discussed using examples in which color filters that are capable of displaying three to six colors are configured, the color filters of the present invention may be formed on a base material, and may include a color filter layer colored a predetermined color and an overcoat layer that is provided on the base material so as to cover the color filter layer and be colored with a color different from the color of the color filter layer, and can be applied to a color filter that is capable of displaying two or more colors.

Also, although in the description above the present invention was discussed using examples in which a color filter substrate is configured by the color filter of the present invention, the color filter of the present invention is not limited thereto and may be provided on an active matrix substrate side, for example. Specifically, a configuration may be possible in which after source lines, gate lines, and thin film transistors are provided on the base material, the color filter layer and an overcoat layer, contained in the color filter of the present invention, are formed above the source lines, the gate lines, and the thin film transistors.

Further, although in the description above the present invention was discussed using examples in which an overcoat layer constituting a planarization layer is used, the overcoat layer of the present invention is not limited thereto and may constitute a protective layer for protecting the color filter layer, for example.

### INDUSTRIAL APPLICABILITY

The present invention is useful as a color filter with the excellent light use efficiency, that can easily improve the degree of freedom of displayed color and expand the color reproduction range, and a display device using the color filter.

### LIST OF REFERENCE NUMERALS

1 Liquid crystal display device (display device)
2 Liquid crystal panel (display unit)
4 Color filter substrate (color filter, pair of substrates)
5 Active matrix substrate (pair of substrates)
21 Base material
22a, 22d Color filter layers
22b First color filter layer
22c Second color filter layer
22e Third color filter layer
22f Fourth color filter layer
23a First overcoat layer (planarization layer)
23b Second overcoat layer (planarization layer)
LC Liquid crystal layer

1. A color filter that displays a plurality of colors that are different from each other, the color filter comprising:
a base material;
a color filter layer that is formed on the base material and colored with a predetermined color; and
an overcoat layer that is provided on the base material so as to cover the color filter layer and colored with a color different from the predetermined color of the color filter layer.

2. The color filter according to claim 1, wherein a plurality of color filter layers colored with colors that are different from each other are used as the color filter layer, and a plurality of overcoat layers colored with colors that are different from each other are used as the overcoat layer.

3. The color filter according to claim 2,
wherein a first overcoat layer colored with any of the colors red (R), green (G), and blue (B), and a second overcoat layer colored with a color, among cyan (C), magenta (M), and yellow (Y), that is in a complementary color relation with the color of the first overcoat layer are used as the plurality of overcoat layers, and
a first color filter layer and a second color filter layer that are provided so as to be covered by the second overcoat layer and are respectively colored with one and the other color of two colors, among cyan (C), magenta (M), and yellow (Y), that are different from the color of the second overcoat layer are used as the plurality of color filter layers.

4. A display device using the color filter according to claim 1.

5. The display device according to claim 4 comprising a display unit that displays information,
wherein a liquid crystal panel is used for the display unit.

6. The display device according to claim 5,
wherein the color filter is used as one substrate of a pair of substrates that sandwich a liquid crystal layer of the liquid crystal panel, and
the overcoat layer constitutes a planarization layer that is provided on the liquid crystal layer side.
